(19) United States
(12) Patent Application Publication
(10) Pub. No.: US 2014/0019415 A1
(43) Pub. Date: Jan. 16, 2014

(54) Method and System for Database Cloud Bursting

(71) Applicant: NEC Laboratories America, Inc., Princeton, NJ (US)

(72) Inventors: Sean Barker, Sunderland, MA (US); Yun Chi, Monte Sereno, CA (US); Vahit Hacigumus, San Jose, CA (US)

(21) Appl. No.: 13/939,652

(22) Filed: Jul. 11, 2013

Related U.S. Application Data
(60) Provisional application No. 61/670,260, filed on Jul. 11, 2012.

(51) Int. Cl. G06F 17/30

(52) U.S. Cl. CPC G06F 17/303
USPC 707/643; 707/654; 707/649

(57) ABSTRACT

A computer implemented method for cloud bursting applied to a database includes employing a database live migration using a database hot backup capability to support database cloud bursting without client service interruption in multitenant databases, ascertaining a critical time to start/redo the database cloud bursting to a public cloud so as to meet a service level agreement SLA while leveraging a private cloud for the database to a maximum level, and determining tenants of the database to burst into the public cloud to responsive to costs and benefits.

### RELATED APPLICATION INFORMATION

This application claims priority to provisional application No. 61/670,260 filed Jul. 11, 2012, the contents of which are incorporated herein by reference

### BACKGROUND OF THE INVENTION

The present invention relates generally to database cloud, and more particularly, to database cloud bursting.

An emerging model in large-scale cloud computing is the hybrid cloud, in which enterprise customers leverage both their existing resources (the ‘private cloud’) and the scalable resources made available via traditional cloud providers (the ‘public cloud’). In this model, enterprises have an incentive to maximally utilize their existing resources, since these resources are available at a largely fixed cost, while using public resources only when necessary to minimize additional costs. One technique to do this is ‘cloud bursting’, in which the workload “bursts” to the public cloud during periods of peak demand, then moves back to local resources once the peak has passed.

Some existing approaches achieve cloud bursting either through virtual machine migration, which is heavyweight and not able to make decisions based on characteristics of a database itself. Other existing approaches only handle file access, where database workloads are not supported.

### BRIEF SUMMARY OF THE INVENTION

The present invention is directed to a computer implemented method for cloud bursting applied to a database includes employing a database live migration using a database hot backup capability to support database cloud bursting without client service interruption in multitenant databases, ascertaining a critical time to start/redo the database cloud bursting to a public cloud so as to meet a service level agreement SLA while leveraging a private cloud for the database to a maximum level, and determining tenants of the database to burst into the public cloud to responsive to costs and benefits.

The present invention is directed to a system for cloud bursting applied to a database, including a processor, code executable by the processor for implementing a database live migration using a database hot backup capability to support database cloud bursting without client service interruption in multitenant databases, code executable by the processor for ascertaining a critical time to start/redo the database cloud bursting to a public cloud so as to meet a service level agreement SLA while leveraging a private cloud for the database to a maximum level, and code executable by the processor for determining tenants of the database to burst into the public cloud to responsive to costs and benefits.

These and other advantages of the invention will be apparent to those of ordinary skill in the art by reference to the following detailed description and the accompanying drawings.

### BRIEF DESCRIPTION OF THE DRAWINGS

FIG. 1 is a flow diagram of for database cloud bursting, in accordance with the invention;

FIG. 2 is a block diagram showing components of the inventive database cloud bursting; and

FIG. 3 shows an exemplary computer to perform the inventive database cloud bursting;

### DETAILED DESCRIPTION

The present invention is directed to cloud bursting for multitenant databases. The invention provides how to achieve database cloud bursting, how to decide when to begin bursting a workload to the public cloud and when to end bursting and migrate back to the private cloud, and how to choose which tenants to move when bursting.

The invention encompasses a framework that addresses the common case of a large-scale data provider servicing many database tenants on a set of multitenant database servers. Using a technique for live database migration based on database hot backup tools, our framework achieves database cloud bursting without service interruption. By modeling the cost and benefit of bursting specific tenants, our framework automatically selects candidates for bursting to cloud-based machines and thereby decreases the dedicated resources required to service the database workload. Our framework is able to efficiently and transparently perform bursting both within a local cluster and to a public cloud such as Amazon EC2.

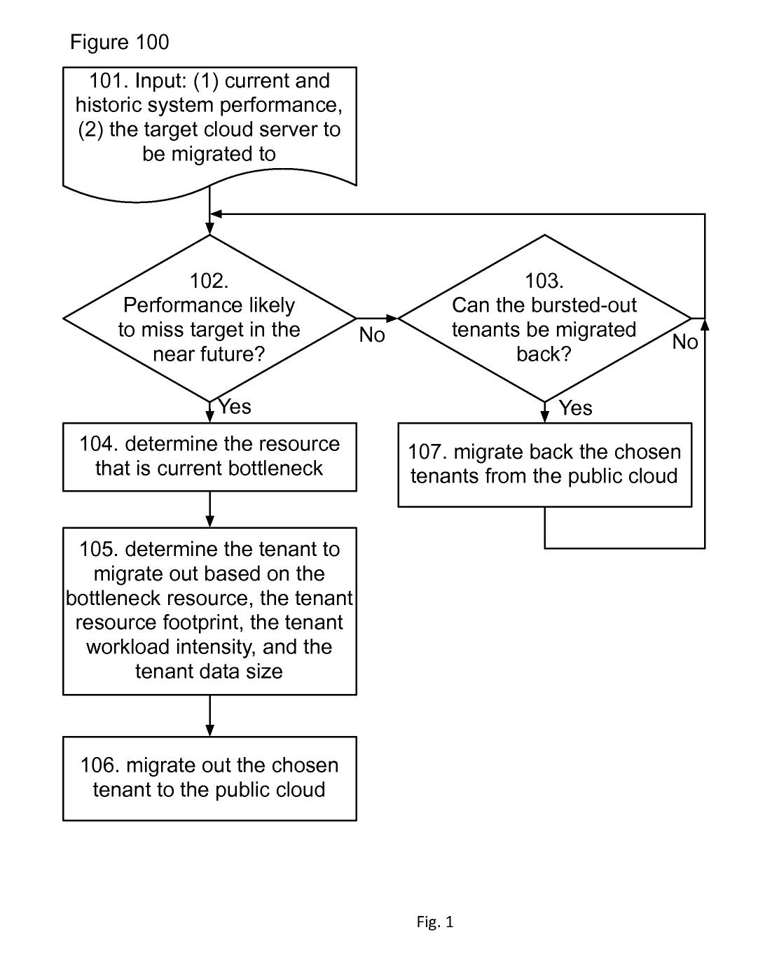

FIG. 1 shows the flow diagram 100 of the inventive database cloud bursting. The system input 101 includes current and historic performance information for the target cloud server to which database migration is contemplated. Responsive to the input 101, the invention checks if performance is likely to miss target in the near future 102. If the answer in decision block 102 is no, the invention checks if bursted-out database tenants can be migrated back 103 from the public cloud. If the answer in the 103 decision block is yes, the invention migrates back the chosen database tenants from the public cloud 107. If the answer in the 103 decision block 103 is no, the invention returns to the 102 decision block, to check if performance is likely to miss the target in the near future. If the answer in the 102 decision block is yes, the invention determines the cloud resource that is the current bottleneck 104. The invention then determines the tenant to migrate out to the public cloud based on the bottleneck resource, the tenant resource footprint, the tenant workload intensity and the tenant data size 105. Responsive to the foregoing determination 105, the invention migrates out to the chosen database tenant to the public cloud.

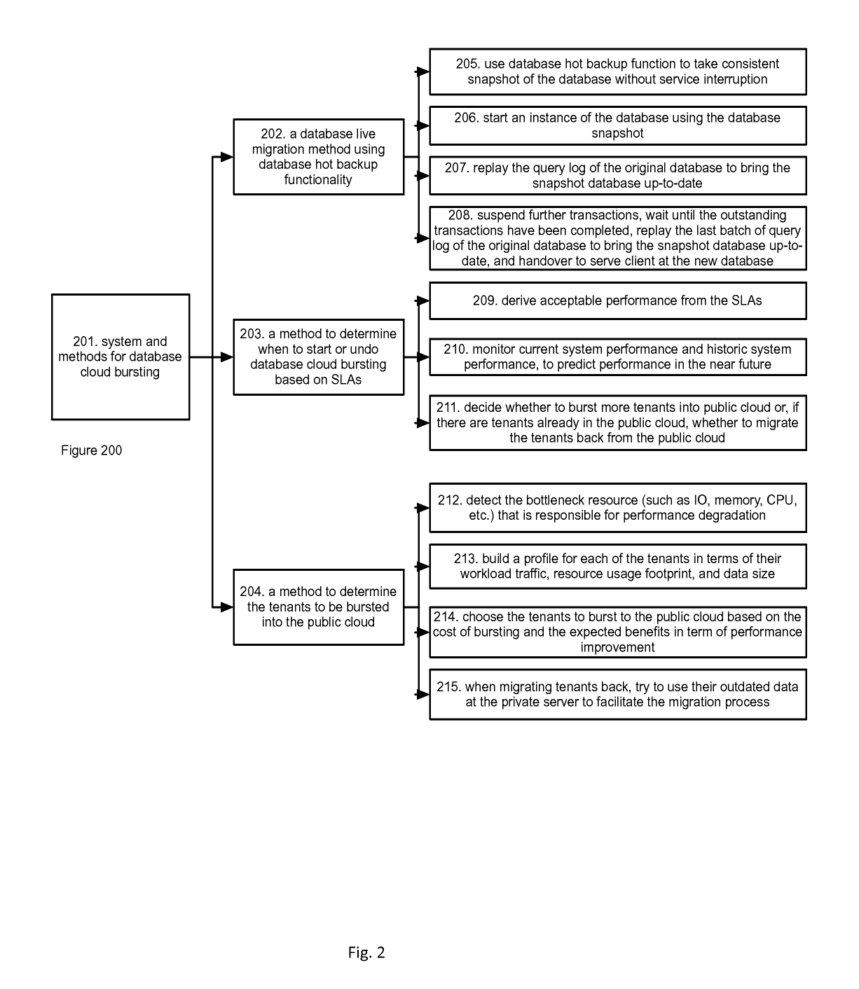

Referring to FIG. 2, there is shown a block diagram 200 detailing aspects of the inventive database cloud bursting. The database cloud bursting 201 encompasses a database live migration using database hot backup functionality 202, determining when to start or undo database cloud bursting based service level agreements SLAs 203, and determining the database tenants to be bursted into the public cloud 204.

Respecting the database live migration aspect 202, the invention uses a database hot backup function to take consistent snapshots of the database without service interruption 205. Then, the invention starts an instance of the database using the database snapshot 206. A replay of the query log of the original database is undertaken to bring the snapshot database up-to-date 207. The invention then, at block 208, suspends further transactions, waits until the outstanding transactions have been completed, replays the last batch of query log of the original database to bring the snapshot database up-to-date, and hands over to the server client at the new database.

Respecting the determination of when to start or undo database cloud bursting based on SLAs 203, the invention derives acceptable performance criteria from the SLAs 209. The invention then monitors current system performance and historic system performance to predict performance in the near future 210. Lastly, the invention decides whether to burst more database tenants into the public cloud or, if there are tenants already in the public cloud, whether to migrate the tenants back from the public cloud 211.

Respecting the determination of the tenants to bursted into the public cloud, the invention detects the bottleneck resource, (such as I/O, memory, CPU, etc.) that is responsible for performance degradation 212. The invention then builds a profile for each of the database tenants in terms of their workload traffic, resource usage footprint, and data size 213. The invention chooses the tenants to burst to the public cloud based on the cost of bursting and the expected benefits in terms of performance improvement 214. Then the invention, when migrating tenants back from the public cloud, attempts to use their outdated data at the private server to facilitate the migration process 215.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device. More details are discussed in U.S. Pat. No. 8,380,557, the content of which is incorporated by reference.

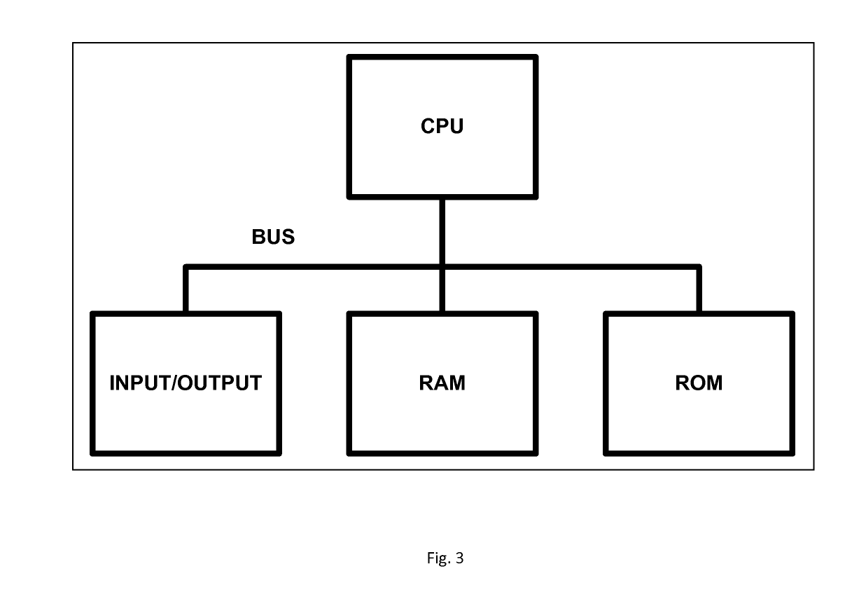

By way of example, a block diagram of a computer to support the system is discussed next in FIG. 3. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

From the foregoing, it can be appreciated that the inventive solution achieves database cloud bursting by using live database migration. This improves the quality of service by eliminating downtime for database clients. Second, the inventive solution takes service level agreements (SLAs) into consideration to decide when to start cloud bursting. Therefore, the inventive solution can ensure the SLAs of the tenants being serviced at the servers. Such a performance guarantee has immediate commercial values. Third, when determining which tenants to burst into the public cloud, the inventive solution considers the cost of bursting and the expected benefits in a holistic way. This makes our solution both more efficient and less costly when compared with a naïve approach.

Cloud bursting is not new, but the inventive cloud bursting applied specifically to databases is new. Other inventive aspects include:
achieving database cloud bursting through live database migration, which generates no client service interruption;
computing the likelihood of missing an SLA in the near future by performance forecasting and the decision of when to start database cloud bursting as well as when to migrate bursted tenants back to the private cloud;
determining the best tenant(s) to burst into the public cloud so as to minimize migration cost, maximize the system performance improvement, and minimize the cost of migrating the tenant back from the public cloud.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. Additional information is provided in an appendix to the application entitled, “Additional Information”. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A computer implemented method for cloud bursting applied to a database, comprising:
employing a database live migration using a database hot backup capability to support database cloud bursting without client service interruption in multitenant databases;
ascertaining a critical time to start/redo the database cloud bursting to a public cloud so as to meet a service level agreement SLA while leveraging a private cloud for the database to a maximum level; and
determining tenants of the database to burst into the public cloud to responsive to costs and benefits.

2. The method of claim 1, wherein the employing step comprises using the database hot backup capability to take consistent snapshots of the database without service interruption.

3. The method of claim 2, wherein the employing step comprises starting an instance of the database using the database snapshot.

4. The method of claim 3, wherein the employing step comprises replaying a query log of an original of the database to bring the snapshot database up to date.

5. The method of claim 4, wherein the employing step comprises suspending further transactions, waiting until the outstanding transactions have been completed, replaying the last batch of query log of the original database to bring the snapshot database up-to-date, and handing over to the server client the new database.

6. The method of claim 1, wherein the ascertaining step comprises deriving an acceptable performance criteria from the SLAs and monitoring current system performance and historic system performance to predict performance in a near future and deciding whether to burst more database tenants into the public cloud or, if there are tenants already in the public cloud, whether to migrate the tenants back from the public cloud.

7. The method of claim 1, wherein the determining step comprises detecting the bottleneck resource responsible for performance degradation.

8. The method of claim 7, wherein the determining step comprises building a profile for each of the database tenants in terms of their workload traffic, resource usage footprint, and data size.

9. The method of claim 8, wherein the determining step comprises choosing the tenants to burst to the public cloud based on a cost of bursting and expected benefits in terms of performance improvement.

10. The method of claim 9, wherein the determining step comprises, when migrating tenants back from the public cloud, attempting to use their outdated data at the private cloud server to facilitate a migration process.

11. A system for cloud bursting applied to a database, comprising:
a processor;
code executable by the processor for implementing a database live migration using a database hot backup capability to support database cloud bursting without client service interruption in multitenant databases;
code executable by the processor for ascertaining a critical time to start/redo the database cloud bursting to a public cloud so as to meet a service level agreement SLA while leveraging a private cloud for the database to a maximum level; and
code executable by the processor for determining tenants of the database to burst into the public cloud to responsive to costs and benefits.

12. The system of claim 11, wherein the employing comprises using the database hot backup capability to take consistent snapshots of the database without service interruption.

13. The system of claim 12, wherein the employing comprises starting an instance of the database using the database snapshot.

14. The system of claim 13, wherein the employing step comprises replaying a query log of an original of the database to bring the snapshot database up to date.

15. The system of claim 14, wherein the employing step comprises suspending further transactions, waiting until the outstanding transactions have been completed, replaying the last batch of query log of the original database to bring the snapshot database up-to-date, and handing over to the server client the new database.

16. The system of claim 11, wherein the ascertaining comprises deriving an acceptable performance criteria from the SLAs and monitoring current system performance and historic system performance to predict performance in a near future and deciding whether to burst more database tenants into the public cloud or, if there are tenants already in the public cloud, whether to migrate the tenants back from the public cloud.

17. The system of claim 11, wherein the determining comprises detecting the bottleneck resource responsible for performance degradation.

18. The system of claim 17, wherein the determining comprises building a profile for each of the database tenants in terms of their workload traffic, resource usage footprint, and data size.

19. The system of claim 18, wherein the determining comprises choosing the tenants to burst to the public cloud based on a cost of bursting and expected benefits in terms of performance improvement.

20. The system of claim 19, wherein the determining comprises, when migrating tenants back from the public cloud, attempting to use their outdated data at the private cloud server to facilitate a migration process.
